(19) United States
(12) Patent Application Publication
(10) Pub. No.: US 2012/0249619 A1
(43) Pub. Date: Oct. 4, 2012

(54) DISPLAY DEVICE

(75) Inventors: Tomoo Furukawa, Osaka-shi (JP); Kazuma Hirao, Osaka-shi (JP); Hirokazu Okuno, Osaka-shi (JP)

(73) Assignee: SHARP KABUSHIKI KAISHA, Osaka-shi, Osaka (JP)

(21) Appl. No.: 13/513,907

(22) PCT Filed: Nov. 2, 2010
(86) PCT No.: PCT/JP2010/069506

§ 371 Date: Jun. 5, 2012

(30) Foreign Application Priority Data
Dec. 28, 2009 (JP) 2009-296838

(51) Int. Cl. G09G 3/36; G09G 5/10

(52) U.S. Cl. 345/691; 345/101

(57) ABSTRACT

In a liquid crystal display device (10), it is determined whether or not a panel temperature (Tp) sensed by a temperature sensor (16) is higher than a predetermined temperature. As the result, when the panel temperature (Tp) is the predetermined temperature or less, an input video signal (V1) is output to a digital gamma conversion part (22). The digital gamma conversion part (22) performs gamma conversion using an LUT (12) on the video signal (V1). The LUT (12) to be used for the gamma conversion stores a result of gamma conversion of obtaining brightness by multiplying brightness corresponding to low gradation-side input gradations by a predetermined magnification. This gamma conversion is allowed to enhance the brightness corresponding to the low gradation-side input gradations of the video signal (V1), and therefore is allowed to improve a response speed of a liquid crystal. Moreover, when the panel temperature (Tp) is higher than the predetermined temperature, the response speed of the liquid crystal is fast. Therefore, the video signal (V1) is output to a timing control part (24) without being subjected to the gamma conversion.

### TECHNICAL FIELD

The present invention relates to display devices, and more particularly to a display device that performs, on video signals, processing responsive to a temperature and processing responsive to a type of the video signal to display an image.

### BACKGROUND ART

In liquid crystal display devices, a liquid crystal has a response speed which differs depending on a variation in a gradation (depending on how the gradation varies). For example, there has been known that, in a liquid crystal for a vertical alignment mode (a normally black mode), a response speed becomes slowest at the time when a gradation varies from black to a halftone. Moreover, the response speed of the liquid crystal becomes slower as a temperature becomes lower. For example, a vehicle-installed liquid crystal display device is required to operate even at an ambient temperature of about −20° C. Under low temperature conditions, however, a liquid crystal has a response speed which becomes extremely slower at the time when the gradation varies from black or a gradation close to black to a halftone. In the case where images to be displayed are moving images, moreover, the response speed of the liquid crystal becomes extremely slower at the time when the gradation varies from black or a gradation close to black to a halftone.

As a method for improving a response speed of a liquid crystal, heretofore, there has been known overshoot drive for applying, to a liquid crystal, a voltage which is higher (or lower) than a voltage to be applied originally. Moreover, Japanese Patent No. 3706486 discloses the following technique. That is, in the case where a liquid crystal panel for a normally black mode displays black, a voltage which is higher than 0 V (more preferably, which is equal to or more than a voltage at which an optical characteristic of a liquid crystal varies and contrast becomes 50 or more) is applied to a liquid crystal layer.

### PRIOR ART DOCUMENT

### Patent Document

Patent Document 1: Japanese Patent No. 3706486

### SUMMARY OF THE INVENTION

### Problems to be Solved by the Invention

In order to perform the overshoot drive, however, there is a necessity to provide a frame memory and a dedicated control circuit. This results in the scale-up and complication of circuitry. Particularly, in the case where a middle-size or small-size liquid crystal display device including a middle-size or small-size liquid crystal panel is used for performing overshoot drive, cost of circuitry for the overshoot drive largely occupies the total device costs. In actual fact, therefore, it becomes considerably difficult to perform the overshoot drive using the middle-size or small-size liquid crystal display device on which severe cost restrictions are imposed.

According to the liquid crystal display device disclosed in Japanese Patent No. 3706486, the voltage to be applied is equal to or more than the voltage at which the optical characteristic of the liquid crystal varies at the time of black display, so that the contrast is reduced. As the result, it may be impossible to realize high contrast which is an advantageous feature in the normally black mode. Moreover, when the voltage to be applied to the liquid crystal layer at the time of black display is varied in accordance with a temperature, a configuration of a ladder resistor included in a data line drive circuit of the liquid crystal panel is not adapted to a V-T characteristic of the liquid crystal panel. As the result, it may be impossible to attain a desired gamma characteristic.

Hence, an object of the present invention is to provide a display device capable of improving a response speed at low cost.

### Solutions to the Problems

A first aspect of the present invention provides a display device performing gamma conversion on an input video signal to display an image, the display device including: a display panel; a digital gamma conversion part performing the gamma conversion on the input video signal; a drive part driving the display panel on the basis of the video signal subjected to the gamma conversion; a timing control part outputting the video signal and a control signal to the drive part at a predetermined timing; a first table to be used when the digital gamma conversion part performs the gamma conversion; and a determination part making a determination whether or not a predetermined condition is satisfied, wherein the first table stores a result of gamma conversion of converting the input video signal so as to obtain brightness by multiplying brightness corresponding to low gradation-side input gradations of the input video signal by a predetermined magnification, and the digital gamma conversion part performs the gamma conversion using the first table when it is determined that the predetermined condition is satisfied.

A second aspect of the present invention provides the display device according to the first aspect of the present invention, further including: a temperature sensing part sensing a temperature of the display panel; and a switch to be switched so as to output the input video signal to one of the digital gamma conversion part and the timing control part, wherein the determination part determines whether or not the temperature sensed by the temperature sensing part is higher than a predetermined value, the switch is switched so as to output the input video signal to the digital gamma conversion part when it is determined that the sensed temperature is the predetermined value or less, and the switch is switched so as to output the input video signal, which is not subjected to the gamma conversion, to the timing control part when it is determined that the sensed temperature is higher than the predetermined value.

A third aspect of the present invention provides the display device according to the first aspect of the present invention, further including: a temperature sensing part sensing a temperature of the display panel; and a second table storing a result of gamma conversion which is obtained by setting at 1 the magnification for the multiplication of the brightness corresponding to all the input gradations of the input video signal, wherein the determination part is included in the digital gamma conversion part to determine whether or not the temperature sensed by the temperature sensing part is higher than a predetermined value, the digital gamma conversion part performs the gamma conversion using the first table when it is determined that the sensed temperature is the predetermined value or less, and the digital gamma conversion part performs the gamma conversion using the second table when it is determined that the sensed temperature is higher than the predetermined value.

A fourth aspect of the present invention provides the display device according to the second or third aspect of the present invention, wherein the first table includes a plurality of tables storing different results of gamma conversion in accordance with a temperature, among the plurality of tables, a table to be used at a lower temperature stores a result of gamma conversion which is obtained by setting the predetermined magnification at a larger value, and the digital gamma conversion part selects one table from the plurality of tables in accordance with the temperature sensed by the temperature sensing part, and performs the gamma conversion using the selected table.

A fifth aspect of the present invention provides the display device according to the first aspect of the present invention, further including: a temperature sensing part sensing a temperature of the display panel; and a third table storing a result of gamma conversion for converting the input gradation of the input video signal into a desired output gradation, wherein the first table stores a result of gamma conversion of converting the input video signal so as to convert the input gradation into the desired output gradation and then obtain brightness by multiplying the brightness corresponding to the low gradation-side input gradations by the predetermined magnification, the determination part is included in the digital gamma conversion part to determine whether or not the temperature sensed by the temperature sensing part is higher than a predetermined value, the digital gamma conversion part performs the gamma conversion using the first table when it is determined that the sensed temperature is the predetermined value or less, and the digital gamma conversion part performs the gamma conversion using the third table when it is determined that the sensed temperature is higher than the predetermined value.

A sixth aspect of the present invention provides the display device according to the first aspect of the present invention, further including: a switch to be switched so as to output the input video signal to one of the digital gamma conversion part and the timing control part in accordance with the result of determination by the determination part, wherein the determination part determines a type of the input video signal, the switch is switched so as to output the input video signal to the digital gamma conversion part when it is determined that the input video signal is a moving image, and the switch is switched so as to output the input video signal, which is not subjected to the gamma conversion, to the timing control part when it is determined that the input video signal is a still image.

A seventh aspect of the present invention provides the display device according to the first aspect of the present invention, further including: a second table storing a result of gamma conversion which is obtained by setting at 1 the magnification for the multiplication of the brightness corresponding to all the input gradations of the input video signal, wherein the determination part is included in the digital gamma conversion part to determine a type of the input video signal, the digital gamma conversion part performs the gamma conversion using the first table when it is determined that the input video signal is a moving image, and the digital gamma conversion part performs the gamma conversion using the second table when it is determined that the input video signal is a still image.

A eighth aspect of the present invention provides the display device according to the first aspect of the present invention, further including: a third table storing a result of gamma conversion for converting the input gradation of the input video signal into a desired output gradation, wherein the first table stores a result of gamma conversion of converting the input video signal so as to convert the input gradation into the desired output gradation and then obtain brightness by multiplying the brightness corresponding to the low gradation-side input gradations by the predetermined magnification, the determination part is included in the digital gamma conversion part to determine a type of the input video signal, the digital gamma conversion part performs the gamma conversion using the first table when it is determined that the input video signal is a moving image, and the digital gamma conversion part performs the gamma conversion using the third table when it is determined that the input video signal is a still image.

A ninth aspect of the present invention provides the display device according to the first aspect of the present invention, wherein the predetermined magnification is larger than 1, but 2 or less.

A tenth aspect of the present invention provides the display device according to the first aspect of the present invention, wherein the digital gamma conversion part converts the input video signal into a video signal which is larger in gradations than the input video signal, the display device further including a pseudo multi-gradation processing part performing pseudo multi-gradation processing on the video signal output from the digital gamma conversion part, and outputting the resultant video signal to the timing control part.

A eleventh aspect of the present invention provides the display device according to the first aspect of the present invention, wherein the display panel is a liquid crystal panel for a normally black mode.

### Effects of the Invention

According to the first aspect of the present invention, when the predetermined condition is satisfied, the input video signal is subjected to the gamma conversion using the first table storing the result of gamma conversion of obtaining the brightness by multiplying the brightness corresponding to the low gradation-side input gradations by the predetermined magnification. Thus, it is possible to prevent a variation in a gradation having a slow response speed, irrespective of whether or not the predetermined condition is satisfied. Moreover, it is possible to improve the response speed at low cost without performing overshoot drive.

According to the second aspect of the present invention, when the temperature of the display panel is the predetermined value or less, the switch is switched toward the digital gamma conversion part, so that the input video signal is output to the digital gamma conversion part. The digital gamma conversion part performs the gamma conversion using the first table on the input video signal. On the other hand, when the temperature of the display panel is higher than the predetermined value, the gradation having the slow response speed does not vary. Therefore, the switch is switched toward the timing control part, so that the input video signal is output as it is to the timing control part. Thus, it is possible to prevent a variation in a gradation having a slow response speed, irrespective of the temperature of the display panel. Moreover, it is possible to improve the response speed at low cost without performing overshoot drive. In addition, a table to be prepared is only the first table. Therefore, it is possible to reduce costs for manufacturing the display device.

According to the third aspect of the present invention, the display device includes, in addition to the first table, the second table storing the result of gamma conversion which is obtained by setting at 1 the magnification for the multiplication of the brightness corresponding to all the input gradations. When the temperature of the display panel is the predetermined value or less, the digital gamma conversion part performs the gamma conversion using the first table on the input video signal. On the other hand, when the temperature of the display panel is higher than the predetermined value, the gradation having the slow response speed does not vary. Therefore, the digital gamma conversion part performs the gamma conversion using the second table on the input video signal. Thus, it is possible to prevent a variation in a gradation having a slow response speed, irrespective of the temperature of the display panel. Moreover, it is possible to improve the response speed at low cost without performing overshoot drive.

According to the fourth aspect of the present invention, when the temperature of the display panel is the predetermined value or less, the digital gamma conversion part selects optimal one of the plurality of tables, and then performs the gamma conversion using the selected table on the input video signal. Thus, it is possible to perform the gamma conversion using the optimal table selected from the plurality of tables in accordance with the temperature of the display panel. Therefore, it is possible to further prevent a variation in a gradation having a slow response speed, irrespective of the temperature of the display panel. Moreover, it is possible to improve the response speed at low cost without performing overshoot drive.

According to the fifth aspect of the present invention, when the temperature of the display panel is the predetermined value or less, the digital gamma conversion part performs the gamma conversion using the first table. More specifically, the digital gamma conversion part converts the input gradation of the input video signal into the desired output gradation, and then multiplies the brightness on the lower gradation side only by the predetermined magnification. On the other hand, when the temperature of the display panel is higher than the predetermined value, the digital gamma conversion part performs the gamma conversion using the third table. Even in the display device capable of displaying the image with the desired output gradation on the basis of the input video signal, thus, it is possible to prevent a variation in a gradation having a slow response speed, irrespective of the temperature of the display panel. Moreover, it is possible to improve the response speed at low cost without performing overshoot drive. In addition, even in the case of changing a gamma value in order to display the image with the desired output gradation, it is possible to prevent a variation in a gradation having a slow response speed, irrespective of the temperature of the display panel. Therefore, it is possible to extend a gamma value setting range.

According to the sixth aspect of the present invention, when the input video signal is a moving image, the switch is switched toward the digital gamma conversion part, so that the input video signal is output to the digital gamma conversion part. The digital gamma conversion part performs the gamma conversion using the first table on the input video signal. On the other hand, when the input video signal is a still image, the switch is switched toward the timing control part, so that the input video signal is output to the timing control part without being subjected to the gamma conversion. Thus, it is possible to prevent a variation in a gradation having a slow response speed, irrespective of the type of the input video signal. Moreover, it is possible to improve the response speed at low cost without performing overshoot drive. In addition, a table to be prepared is only the first table. Therefore, it is possible to reduce costs for manufacturing the display device.

According to the seventh aspect of the present invention, the display device includes, in addition to the first table, the second table storing the result of gamma conversion which is obtained by setting at 1 the magnification for the multiplication of the brightness corresponding to all the input gradations. When the input video signal is a moving image, the digital gamma conversion part performs the gamma conversion using the first table on the input video signal. On the other hand, when the input video signal is a still image, the gradation having the slow response speed does not vary. Therefore, the digital gamma conversion part performs the gamma conversion using the second table on the input video signal. Thus, it is possible to prevent a variation in a gradation having a slow response speed, irrespective of the type of the input video signal. Moreover, it is possible to improve the response speed at low cost without performing overshoot drive.

According to the eighth aspect of the present invention, when the input video signal is a moving image, the digital gamma conversion part performs the gamma conversion using the first table. More specifically, the digital gamma conversion part converts the input gradation of the input video signal into the desired output gradation, and then multiplies the brightness on the lower gradation side only by the predetermined magnification. On the other hand, when the input video signal is a still image, the digital gamma conversion part performs the gamma conversion using the third table. Even in the display device capable of displaying the image with the desired output gradation on the basis of the input video signal, thus, it is possible to prevent a variation in a gradation having a slow response speed, irrespective of the type of the input video signal. Moreover, it is possible to improve the response speed at low cost without performing overshoot drive. In addition, even in the case of changing a gamma value in order to display the image with the desired output gradation, it is possible to prevent a variation in a gradation having a slow response speed, irrespective of the type of the input video signal. Therefore, it is possible to extend a gamma value setting range.

According to the ninth aspect of the present invention, it is possible to prevent image deterioration from occurring when an input video signal on a high gradation side is saturated by the gamma conversion so that the contrast lacks in balance.

According to the tenth aspect of the present invention, it is possible to realize multi-gradation display exceeding the ability of the drive part by performing the gamma conversion so as to increase the number of gradations of the video signal and then performing the pseudo multi-gradation processing.

According to the eleventh aspect of the present invention, it is possible to improve the response speed of the liquid crystal at low cost in the display device including the liquid crystal panel for the normally black mode.

### BRIEF DESCRIPTION OF THE DRAWINGS

FIG. 1 is a block diagram showing a configuration of a liquid crystal display device according to a first embodiment of the present invention.

FIG. 2 is a diagram showing an example of a result of processing performed by a pseudo multi-gradation processing part of the liquid crystal display device shown in FIG. 1.

FIG. 3 is a diagram showing processing performed by a digital gamma conversion part of the liquid crystal display device shown in FIG. 1.

FIG. 4 is a diagram showing a relation between an input gradation and a transmittance of a liquid crystal panel in the liquid crystal display device shown in FIG. 1.

FIG. 5 is a table showing a response speed of a conventional liquid crystal display device.

FIG. 6 is a table showing a response speed of the liquid crystal display device shown in FIG. 1.

FIG. 7 is a block diagram showing a configuration of a liquid crystal display device according to a first modification example of the first embodiment.

FIG. 8 is a block diagram showing a configuration of a liquid crystal display device according to a second modification example of the first embodiment.

FIG. 9 is a block diagram showing a configuration of a liquid crystal display device according to a third modification example of the first embodiment.

FIG. 10 is a block diagram showing a configuration of a liquid crystal display device according to a second embodiment of the present invention.

FIG. 11 is a block diagram showing a configuration of a liquid crystal display device according to a modification example of the second embodiment.

FIG. 12 is a table showing a response speed of a conventional liquid crystal display device including a liquid crystal panel for a white mode.

FIG. 13 is a table showing a response speed of the liquid crystal display device, which includes a liquid crystal panel for a white mode, according to the first embodiment.

### EMBODIMENTS OF THE INVENTION

### 1. First Embodiment

### <1.1 Configuration of Liquid Crystal Display Device>

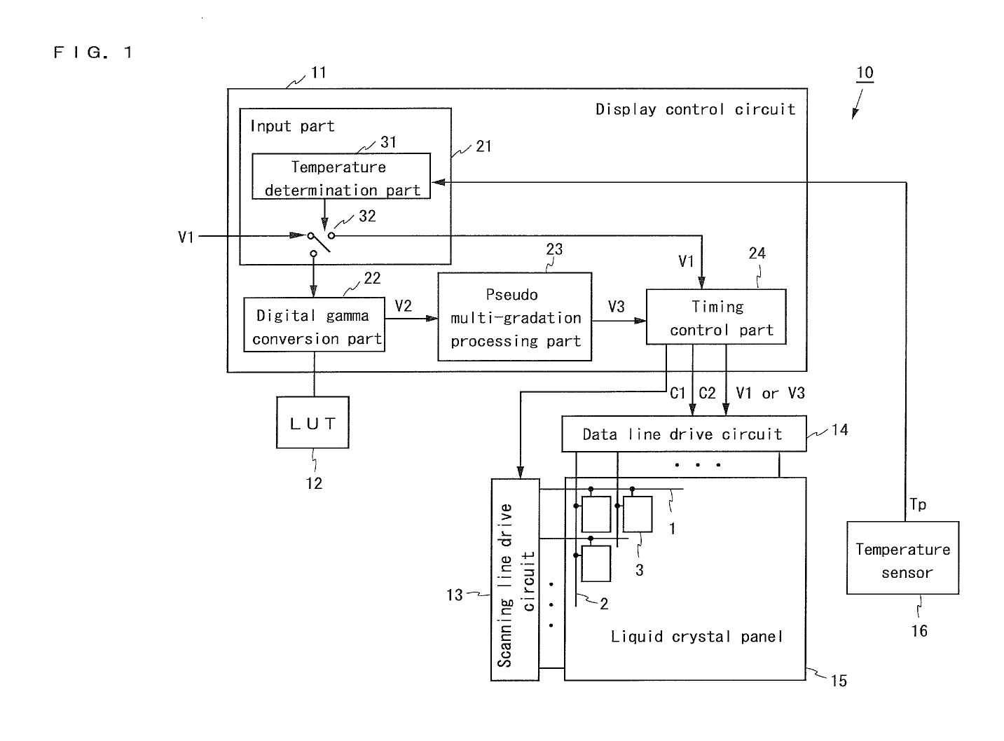

FIG. 1 is a block diagram showing a configuration of a liquid crystal display device 10 according to a first embodiment of the present invention. As shown in FIG. 1, the liquid crystal display device 10 includes a display control circuit 11, an LUT (Look Up Table) 12, a scanning line drive circuit 13, a data line drive circuit 14, a liquid crystal panel 15 and a temperature sensor 16. The display control circuit 11 includes an input part 21, a digital gamma conversion part 22, a pseudo multi-gradation processing part 23 and a timing control part 24. The input part 21 includes a temperature determination part 31 and a switch 32. Herein, the liquid crystal display device 10 has no circuitry for overshoot drive.

As shown in FIG. 1, the liquid crystal panel 15 includes a plurality of scanning lines 1, a plurality of data lines 2 and a plurality of pixels 3. The scanning lines 1 are arranged in parallel with one another, and the data lines 2 are arranged in parallel with one another so as to be orthogonal to the scanning lines 1. The pixels 3 are arranged at intersections between the scanning lines 1 and the data lines 2, and are connected to one scanning line 1 and one data line 2, respectively. The liquid crystal panel 15 is a liquid crystal panel for a normally black mode (a vertical alignment mode) in an MVA (Multi-domain Vertical Alignment) method or the like.

The scanning line drive circuit 13 and the data line drive circuit 14 constitute a drive part for driving the liquid crystal panel 15. The scanning line drive circuit 13 sequentially selects one scanning line 1 from the plurality of scanning lines 1, and then applies a predetermined voltage (e.g., a HIGH-level voltage) to the selected scanning line 1. The pixels 3 connected to the scanning lines 1 applied with the predetermined voltage are selected sequentially for each of the scanning lines 1. The data line drive circuit 14 applies, to each data line 2, a voltage responsive to a video signal V1 or a video signal V3 output from the display control circuit 11. Thus, the voltage applied to each data line 2 is written to each of the selected pixels 3. Brightness of the pixels 3 varies in accordance with the voltage written to the pixel 3. Accordingly, when the voltage responsive to the video signal is written to all the pixels 3 in the liquid crystal panel 15, a desired image can be displayed on the liquid crystal panel 15. Herein, as a voltage to be applied to a liquid crystal is higher, a response speed of the liquid crystal becomes faster. As the result, it becomes possible to shorten time for switchover between images displayed on the liquid crystal panel 15.

A video signal V1 is input to the input part 21 of the liquid crystal display device 10 from the outside. The input video signal V1 is fed to the switch 32 of the input part 21. The temperature sensor 16 is provided on a surface of the liquid crystal panel 15, and senses a surface temperature of the liquid crystal panel 15. The temperature sensed by the temperature sensor 16 (hereinafter, referred to as the panel temperature Tp) is input to the temperature determination part 31. The temperature determination part 31 determines whether or not the panel temperature Tp is higher than a predetermined temperature (−10° C. in this embodiment), and switches the switch 32 in accordance with the result of determination.

More specifically, when it is determined that the panel temperature Tp is −10° C. or less, the switch 32 is switched toward the digital gamma conversion part 22. The switch 32 is switched in accordance with the video signal V1, and the video signal V1 is input to the digital gamma conversion part 22. On the other hand, when it is determined that the panel temperature Tp is higher than −10° C., the switch 32 is switched toward the timing control part 24. Thus, the video signal V1 is input to the timing control part 24, but is not input to the digital gamma conversion part 22 and the pseudo multi-gradation processing part 23. Therefore, the video signal V1 is not subjected to gamma conversion and pseudo multi-gradation processing.

When the panel temperature Tp is −10° C. or less, the digital gamma conversion part 22 performs gamma conversion using the LUT 12 on the video signal V1 to output a video signal V2 which is larger in gradations than the video signal V1. The pseudo multi-gradation processing part 23 performs pseudo multi-gradation processing on the video signal V2 to output a video signal V3 which is equal in gradations to the video signal V1.

The timing control part 24 outputs a control signal C1 to the scanning line drive circuit 13, and also outputs a control signal C2 to the data line drive circuit 14. The control signal C1 contains a gate start pulse, a gate clock and the like, and the control signal C2 contains a source start pulse, a source clock and the like. Moreover, the timing control part 24 outputs a video signal to the data line drive circuit 14 at an appropriate timing. More specifically, the timing control part 24 outputs the video signal V3 when the panel temperature Tp is −10° C. or less, and outputs the video signal V1 when the panel temperature Tp is higher than −10° C.

### <1.2 Operations of Liquid Crystal Display Device>

It is assumed in the following description that each of the video signals V1 and V3 is a 6-bit video signal and the video signal V2 is an 8-bit video signal. In this case, when the panel temperature Tp is −10° C. or less, the digital gamma conversion part 22 generates the 8-bit video signal V2 on the basis of the 6-bit video signal V1, and the pseudo multi-gradation processing part 23 generates the 6-bit video signal V3 on the basis of the 8-bit video signal V2. The predetermined temperature is set at −10° C. in this embodiment because of the following reason. That is, according to the experiment conducted by the inventors, when the predetermined temperature is −10° C. or less, a response speed of a liquid crystal becomes extremely slower, so that an image to be displayed on the liquid crystal panel 15 blurs outstandingly. The predetermined temperature is set appropriately in accordance with a liquid crystal panel to be used.

The pseudo multi-gradation processing part 23 performs frame rate control to be described below, for example. More specifically, the pseudo multi-gradation processing part 23 divides the video signal V2 into upper 6 bits and lower 2 bits, and outputs, as the video signal V3, a value of the upper 6 bits or a value obtained by adding 1 to the value of the upper 6 bits. The pseudo multi-gradation processing part 23 determines which values to output on the basis of a value of the lower 2 bits. In the case where the value of the lower 2 bits is N (N: an integer from 0 or more to 3 or less), with regard to consecutive four frames, the value of the upper 6 bits is output in the (4−N) frames, and the value obtained by adding 1 to the value of the upper 6 bits is output in the remaining N frames. Moreover, a method of selecting N frames from the consecutive four frames differs among adjacent four pixels.

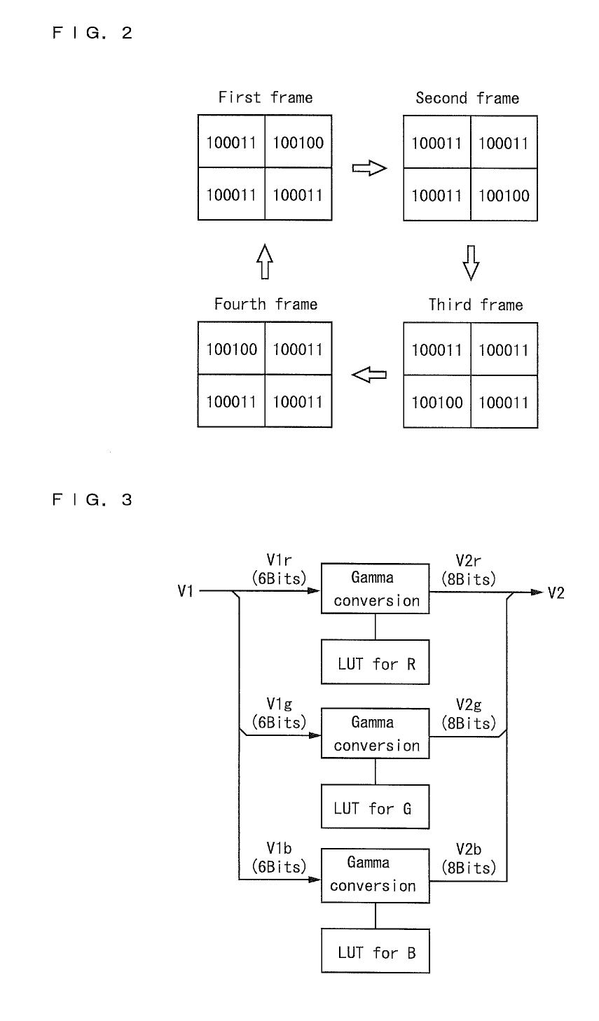

FIG. 2 is a diagram showing an example of a result of processing performed by the pseudo multi-gradation processing part 23. FIG. 2 shows values of the video signal V3 in four frames with regard to adjacent four pixels in the case where the video signal V2 takes a value of 10001101 (binary representation). In this case, the value of the upper 6 bits of the video signal V2 is 100011 (binary representation), and the value of the lower 2 bits of the video signal V2 is 1. With regard to the consecutive four frames, accordingly, the video signal V3 takes a value of 100011 (binary representation) in the three frames and takes a value of 100100 (binary representation) in the remaining one frame. Moreover, the video signal V3 takes a value of 100100 (binary representation) in the first frame with regard to the upper right pixel, in the second frame with regard to the lower right pixel, in the third frame with regard to the lower left pixel, and in the fourth frame with regard to the upper left pixel.

The brightness of the pixels 3 is set at a level corresponding to the value of the upper 6 bits of the video signal V2 or a level which is higher by one step than the level. Accordingly, the brightness of the pixels 3 is averaged in terms of time to fall between the two levels. Moreover, when the pixels 3 are arranged in a two-dimensional manner, the brightness of the pixels 3 is also averaged in terms of space. As described above, the frame rate control allows gradation display corresponding to 8 bits (256-gradation display) using the data line drive circuit 14 which operates on the basis of the 6-bit video signal V3. Moreover, the pseudo multi-gradation processing part 23 may perform the pseudo multi-gradation processing on the video signal V2 by a method other than the frame rate control (e.g., an error diffusion method).

FIG. 3 is a diagram showing processing performed by the digital gamma conversion part 22. The video signal V1 to be input to the digital gamma conversion part 22 contains a 6-bit red component V1r, a 6-bit green component V1g and a 6-bit blue component V1b. The LUT 12 includes an LUT for R to be utilized for gamma conversion of the red component V1r, an LUT for G to be utilized for gamma conversion of the green component V1g, and an LUT for B to be utilized for gamma conversion of the blue component V1b.

The digital gamma conversion part 22 performs processing of converting the 6-bit red component V1r into an 8-bit red component V2r through the use of the LUT for R, processing of converting the 6-bit green component V1g into an 8-bit green component V2g through the use of the LUT for G, and processing of converting the 6-bit blue component V1b into an 8-bit blue component V2b through the use of the LUT for B, independently of one another. As described above, the digital gamma conversion part 22 performs the gamma conversion of the red component V1r, the gamma conversion of the green component V1g and the gamma conversion of the blue component V1b on the 6-bit video signal V1, independently of one another, to generate 8-bit video signals V2r, V2g and V2b, respectively. Herein, data to be stored in the three different LUTs may be equal to or different from one another. In the case where data to be stored in the three different LUTs are different from one another, different types of gamma conversion can be performed on the respective colors.

The LUT 12 stores the value of the video signal V2 (hereinafter, referred to as the output gradation) with this value correlated with the value of the video signal V1 (hereinafter, referred to as the input gradation). The digital gamma conversion part 22 reads out the output gradation correlated with the input gradation from the LUT 12 to convert the video signal V1 into the video signal V2, and then outputs the converted video signal V2 to the pseudo multi-gradation processing part 23.

Next, description will be given of the gamma conversion performed by the digital gamma conversion part 22. The digital gamma conversion part 22 converts the video signal V1 into the 8-bit video signal V2 through the use of the LUT 12 as described above. In the following, for simplification of the description, it is assumed that the digital gamma conversion part 22 converts the 6-bit video signal V1 into a 6-bit video signal, and then outputs the converted video signal to the timing control part 24. Herein, it is also assumed that the liquid crystal panel 15 is a liquid crystal panel that allows 64-gradation display. Moreover, an input gradation is represented by X (0≦X≦63), and a gamma value of the liquid crystal panel 15 is represented by γ (γ=2.2). The input gradations X are correlated with the brightness y of an image to be displayed on the liquid crystal panel 15 in accordance with Equation (1) to be described later. Thus, the liquid crystal panel 15 displays the image having the brightness y corresponding to the input gradations X.

y=(X/63) [symbol] γ (1)

In this case, a voltage corresponding to the brightness y is applied to the liquid crystal of the pixel 3. In the case where the liquid crystal panel 15 is a liquid crystal panel for a normally black mode, when the panel temperature Tp becomes −10° C. or less, the response speed of the liquid crystal becomes extremely slower on the condition that the input gradation X is a gradation on a low gradation side. In order to improve the response speed of the liquid crystal at −10° C. or less, there is a necessity to apply a higher voltage to the liquid crystal, that is, there is a necessity to enhance the brightness of the image. Therefore, in response to the low gradation-side input gradation X, brightness Y is obtained by multiplying the brightness y obtained from Equation (1) by k (1<k≦2). In this specification, the method of obtaining the brightness Y by multiplying the brightness y corresponding to the low gradation-side input gradations X by k is referred to as the gamma conversion.

Y=k*(X/63) [symbol] γ (2)

When the gamma conversion is performed on the video signal V1 in accordance with Equation (2), the brightness of the image corresponding to the low gradation-side input gradations X is higher by k than the brightness of the image based on the video signal which is not subjected to the gamma conversion. Herein, the brightness of the image is set in accordance with the transmittance of the image and the brightness of a backlight (not shown). In the case of taking the brightness of the backlight into no consideration, however, the brightness of the image becomes equal to the transmittance of the liquid crystal panel 15. The transmittance of the liquid crystal panel 15 becomes equal to a voltage to be applied to the liquid crystal, that is, an output gradation. As the result, the brightness Y of the image to be represented by Equation (2) becomes equal to the output gradation.

According to the experiment conducted by the inventors, in the case of k>2 in Equation (2), when the input gradation X becomes higher than a 32nd gradation, the brightness Y is saturated, the contrast lacks in balance, and image deterioration occurs. Similarly, in the case of k=1.5, when the input gradation X becomes higher than a 40th gradation, the brightness Y is saturated, the contrast lacks in balance, and image deterioration occurs. In other words, Equation (2) can be applied when the input gradation X is the 40th gradation or less in the case of k=1.5. Moreover, Equation (2) can be applied when the input gradation X is the 32nd gradation or less in the case of k=2.

In the case of k=1.5, for example, when the input gradations X range from a 0th gradation to a 40th gradation, the LUT 12 stores output gradations correlated with the input gradations X on the basis of Equation (2). When the input gradation X is on a high gradation side with respect to the 40th gradation, an operator adjusts the output gradation so as not to saturate the video signal V2 and so as to smoothly change a gamma characteristic, and additionally stores the adjusted output gradation in the LUT 12. Thus, the LUT 12 stores a result of gamma conversion adapted to the gamma characteristic of the liquid crystal panel 15 at −10° C. or less. Typically, the input gradations X of the video signal V1 are on the low gradation side in many instances. Therefore, when Equation (2) is applied for the low gradation-side input gradations X, images displayed on the liquid crystal panel 15 are switched in a short time. In this case, it is possible to prevent a blur which is apt to occur at the time of switchover of images.

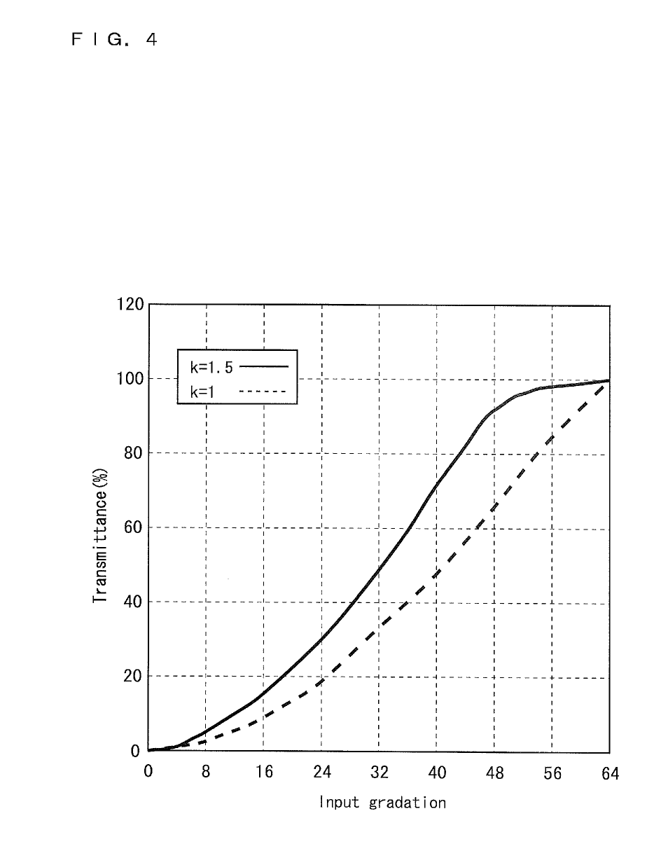

FIG. 4 is a diagram showing a relation between the input gradation X and the transmittance of the liquid crystal panel 15 in the case of performing the gamma conversion using the LUT 12. FIG. 4 shows a curve indicating the relation between the input gradation and the transmittance in the case of k=1.5 and a curve indicating the relation between the input gradation and the transmittance in the case of k=1. As shown in FIG. 4, it is apparent that the transmittance in the case of k=1.5 is higher than the transmittance in the case of k=1.0 with regard to all the input gradations X. As described above, the transmittance of the liquid crystal panel 15 in the case of k=1.5 is high because the voltage to be applied to the liquid crystal is high. Thus, the response speed of the liquid crystal in the case of k=1.5 becomes faster than that in the case of k=1.0. In FIG. 4, as the transmittance is higher, the response speed of the liquid crystal becomes faster. With regard to the input gradations X, the gradation on the low gradation side is smaller in transmittance increasing ratio than the gradation close to the 40th gradation. In order that it looks as if the response speed of the liquid crystal is further improved, it is preferable to improve the transmittance increasing ratio on the low gradation side rather than a transmittance increasing ratio near the 40th gradation. As shown in FIG. 4, the transmittance relative to the low gradation-side input gradation X in the case of k=1.5 is larger than that in the case of k=1. Therefore, it looks as if the response speed of the liquid crystal is further improved.

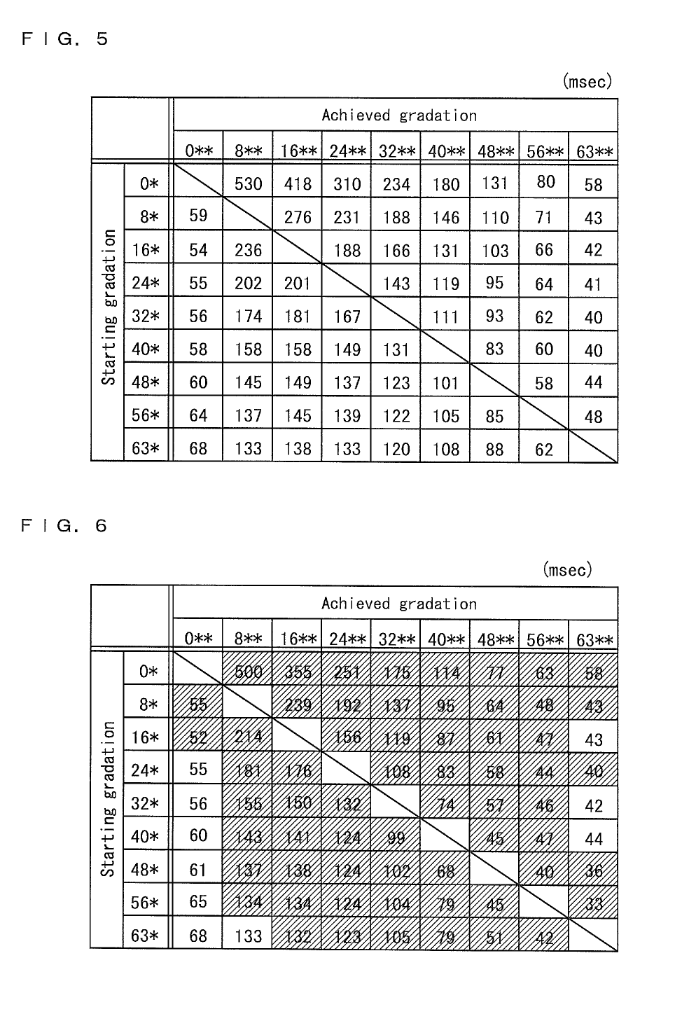

Next, description will be given of effects of the liquid crystal display device 10 according to this embodiment with the liquid crystal display device 10 compared with a liquid crystal display device including an LUT storing output gradations correlated with input gradations X in the case of k=1 in Equation (2) even at a low temperature (hereinafter, referred to as a conventional liquid crystal display device). FIG. 5 is a table showing a response speed of the conventional liquid crystal display device at −20° C. FIG. 6 is a table showing the response speed of the liquid crystal display device 10 according to this embodiment at −20° C. In FIGS. 5 and 6, a starting gradation indicates the gradation of an image displayed precedingly, and an achieved gradation indicates the gradation of an image displayed currently. In FIG. 5, for example, a value of 310 msec in the case where the starting gradation is a 0th gradation and the achieved gradation is a 24th gradation indicates that a time required for changing a 0-gradation image to a 24-gradation image (a response time) is 310 msec.

As shown in FIG. 5, the response speed of the conventional liquid crystal display device was extremely slow at the time when the gradation varies from black or a gradation close to black to a halftone under the low temperature condition. On the other hand, the liquid crystal display device 10 performs the gamma conversion to multiply the brightness corresponding to the low gradation-side gradations by k among the brightness of the liquid crystal panel 15 displaying the image based on the video signal V1 under the lower temperature condition. As shown in FIG. 6, thus, in almost all the gradations, the response time of the liquid crystal is shorter than the response time of the conventional liquid crystal display device, and the response speed of the liquid crystal is improved. Thus, it is possible to prevent a variation in a gradation in which a response speed of the liquid crystal is slow (specifically, a variation in a gradation from black or a gradation close to black to a halftone) and to improve the response speed of the liquid crystal at a low temperature.

In FIG. 6, moreover, a hatched column indicates gamma conversion by which a response time becomes shortened. As shown in FIG. 6, particularly, when the input gradations X range from a 0th gradation (black) to a 16th gradation, the response time of the liquid crystal can be shortened considerably. In the conventional liquid crystal display device, further, the maximum response time is 530 msec at −20° C. In the liquid crystal display device 10, on the other hand, the maximum response time can be shortened up to 500 msec, and the response time can be set at 200 msec or less with regard to almost all the input gradations X.

### <1.3 Effects>

According to the first embodiment, the liquid crystal display device 10 according to this embodiment includes: the liquid crystal panel 15; the input part 21 feeding the input video signal V1 to the digital gamma conversion part 22 when the panel temperature Tp is −10° C. or less; the digital gamma conversion part 22 performing the gamma conversion on the video signal V1; the scanning line drive circuit 13 and the data line drive circuit 14 each driving the liquid crystal panel 15 on the basis of the video signal V3 obtained by performing the pseudo multi-gradation processing on the video signal V2 subjected to the gamma conversion; the temperature sensor 16 sensing the temperature of the liquid crystal panel 15; and the LUT 12 storing the result of gamma conversion of obtaining the video signal V2 by multiplying the brightness corresponding to the low gradation-side input gradations X by k, respectively, among the brightness of the images based on the video signals V1. The digital gamma conversion part 22 performs the gamma conversion using the LUT 12 on the video signal V1 when the panel temperature Tp sensed by the temperature sensor 16 is −10° C. or less. According to the liquid crystal display device 10, it is possible to prevent a variation in a gradation having a slow response speed, irrespective of a temperature of the liquid crystal panel 15. Moreover, it is possible to improve a response speed at low cost without performing overshoot drive. In addition, when the panel temperature Tp is higher than −10° C., the gamma conversion is not performed. Therefore, there is no necessity to provide an LUT for the gamma conversion. That is, an LUT to be prepared is only the LUT 12. Thus, it is possible to reduce costs for manufacturing the liquid crystal display device 10.

Further, the numeric value of k to be used for performing the gamma conversion and stored in the LUT 12 is set within the range of 1<k≦2. Thus, it is possible to prevent such a situation that the brightness Y of the image is saturated in the high gradation-side video signal V1, the contrast lacks in balance, and the image deterioration occurs.

Moreover, the digital gamma conversion part 22 converts the video signal V1 into the video signal V2 which is larger in gradations than the video signal V1. The liquid crystal display device 10 further includes the pseudo multi-gradation processing part 23 performing the pseudo multi-gradation processing on the video signal V2 and outputting the resultant video signal V3 to the timing control part 24. Thus, it is possible to realize multi-gradation display exceeding the ability of the drive part by performing the gamma conversion so as to increase the number of gradations of the video signal V2 and then performing the pseudo multi-gradation processing.

### <1.4 First Modification Example>

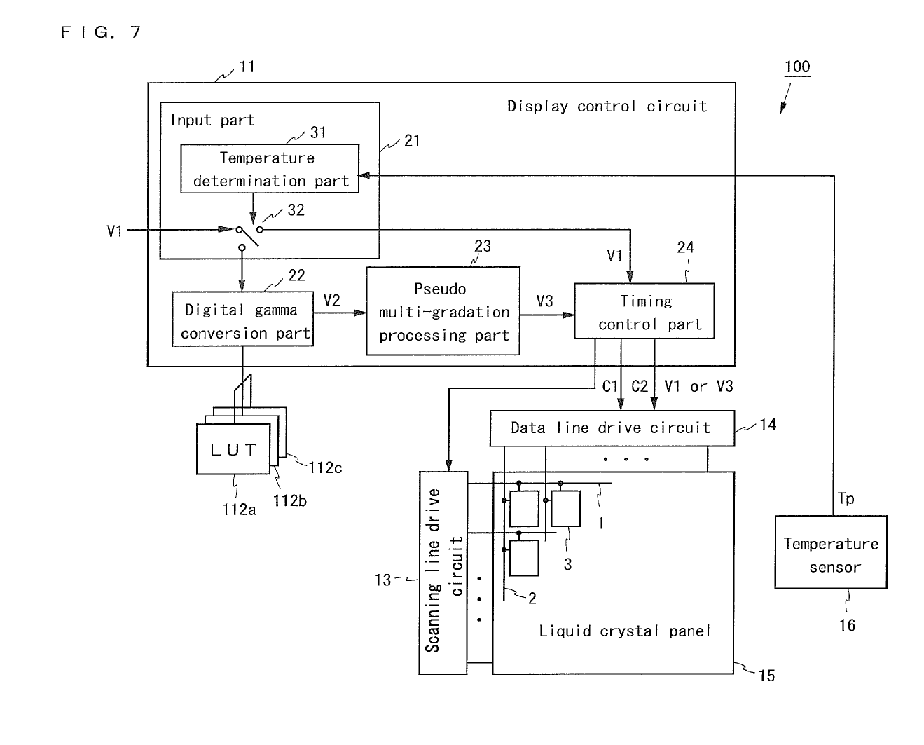

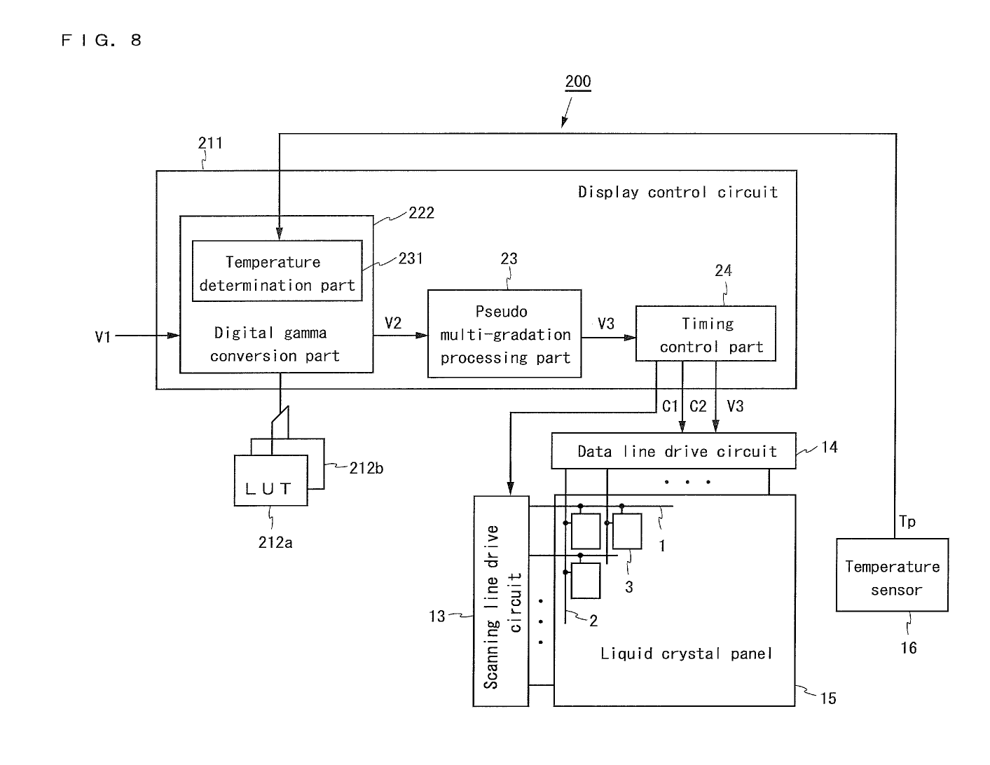

FIG. 7 is a block diagram showing a configuration of a liquid crystal display device 100 according to a first modification example of the first embodiment of the present invention. As shown in FIG. 7, the liquid crystal display device 100 includes a display control circuit 11, a plurality of (three in this modification example) LUTs 112a to 112c, a scanning line drive circuit 13, a data line drive circuit 14, a liquid crystal panel 15 and a temperature sensor 16. The display control circuit 11 includes an input part 21, a digital gamma conversion part 22, a pseudo multi-gradation processing part 23 and a timing control part 24. The input part 21 includes a temperature determination part 31 and a switch 32. In the liquid crystal display device 100 according to this modification example, constituent elements which are identical with those of the liquid crystal display device 10 according to the first embodiment are denoted with the same reference symbols in the first embodiment, and the description thereof will not be given here.

The liquid crystal display device 100 shown in FIG. 7 is different from the liquid crystal display device 10 shown in FIG. 1 in the following point. That is, the three LUTs 112a to 112c storing results of gamma conversion which are obtained on the basis of values of k differing depending on a panel temperature Tp, respectively, are provided in place of the LUT 12. When the panel temperature Tp sensed by the temperature sensor 16 is a predetermined temperature or less (−10° C. in this modification example), the digital gamma conversion part 22 selects one LUT from the three LUTs 112a to 112c in accordance with the panel temperature Tp sensed by the temperature sensor 16, and performs gamma conversion using the selected LUT on an input video signal V1 to output a video signal V2, which is larger in gradations than the video signal V1, to the pseudo multi-gradation processing part 23.

The three LUTs 112a to 112c employ different values of k in Equation (2) to be used for performing gamma conversion on the basis of a low gradation-side input gradation X. The LUT to be used when the panel temperature Tp is lower employs a higher value of k. For example, the LUT 112a stores a result of gamma conversion which is obtained in the case of k=1.2, and is selected when the panel temperature Tp is higher than −20° C., but is −10° C. or less. The LUT 112b stores a result of gamma conversion which is obtained in the case of k=1.5, and is selected when the panel temperature Tp is higher than −30° C., but is −20° C. or less. The LUT 112c stores a result of gamma conversion which is obtained in the case of k=2.0, and is selected when the panel temperature Tp is −30° C. or less. In the pseudo multi-gradation processing part 23, processing to be performed after pseudo multi-gradation processing is identical with that in the liquid crystal display device 10, and therefore the description thereof will not be given here.

According to the first modification example, when the panel temperature Tp is −10° C. or less, the digital gamma conversion part 22 selects one LUT from the three LUTs 112a to 112c in accordance with the panel temperature Tp sensed by the temperature sensor 16, and performs the gamma conversion using the selected LUT. That is, the optimal one of the LUTs is selected in accordance with the temperature of the liquid crystal panel 15, and an input video signal V1 can be subjected to gamma conversion using the selected LUT. Therefore, it is possible to perform more preferable gamma conversion. According to the liquid crystal display device 100, thus, it is possible to further prevent a variation in a gradation having a slow response speed, irrespective of a temperature of the liquid crystal panel 15. Moreover, it is possible to further improve a response speed at low cost without performing overshoot drive.

### <1.5 Second Modification Example>

FIG. 8 is a block diagram showing a configuration of a liquid crystal display device 200 according to a second modification example of the first embodiment of the present invention. As shown in FIG. 8, the liquid crystal display device 200 includes a display control circuit 211, two LUTs 212a and 212b, a scanning line drive circuit 13, a data line drive circuit 14, a liquid crystal panel 15 and a temperature sensor 16. The display control circuit 211 includes a digital gamma conversion part 222, a pseudo multi-gradation processing part 23 and a timing control part 24. The digital gamma conversion part 222 includes a temperature determination part 231. In the liquid crystal display device 200 according to this modification example, constituent elements which are identical with those of the liquid crystal display device 10 according to the first embodiment are denoted with the same reference symbols in the first embodiment, and the description thereof will not be given here.

The liquid crystal display device 200 shown in FIG. 8 is different from the liquid crystal display device 10 shown in FIG. 1 in the following point. That is, the temperature sensor 16 senses a panel temperature Tp of the liquid crystal panel 15, and the sensed panel temperature Tp is input to the temperature determination part 231 of the digital gamma conversion part 222. The temperature determination part 231 determines whether or not the panel temperature Tp is higher than a predetermined temperature (−10° C. in this modification example). The digital gamma conversion part 222 selects one LUT from the LUTs 212a and 212b in accordance with the result of determination by the temperature determination part 231.

The LUTs 212a and 212b have different values of k in Equation (2), respectively. As in the LUT 12, the LUT 212a stores a result of gamma conversion which is obtained by multiplying brightness corresponding to low gradation-side input gradations X by k (=1.5). The LUT 212b stores a result of gamma conversion which is obtained by multiplying brightness corresponding to all input gradations by k (=1). The digital gamma conversion part 222 selects the LUT 212a when the panel temperature Tp is −10° C. or less, and selects the LUT 212b when the panel temperature Tp is higher than −10° C. Then, the digital gamma conversion part 222 performs gamma conversion using the selected LUT to output a video signal V2, which is larger in gradations than a video signal V1, to the pseudo multi-gradation processing part 23. In the pseudo multi-gradation processing part 23, processing to be performed after pseudo multi-gradation processing is identical with that in the liquid crystal display device 10, and therefore the description thereof will not be given here.

According to the second modification example, when the panel temperature Tp is −10° C. or less, the digital gamma conversion part 222 performs the gamma conversion using the LUT 212a on the video signal V1. On the other hand, when the panel temperature Tp is higher than −10° C., the digital gamma conversion part 222 performs the gamma conversion using the LUT 212b on the video signal V1. Thus, it is possible to prevent a variation in a gradation having a slow response speed, irrespective of the panel temperature Tp. Moreover, it is possible to improve a response speed at low cost without performing overshoot drive.

With regard to the liquid crystal display device 200, in the case where the gamma characteristic of the video signal V1 displayed on the liquid crystal panel 15 is displaced from a desired gamma characteristic (for example, γ=2.2), there is a necessity to correct the video signal V2 subjected to the gamma conversion by the digital gamma conversion part 222 such that the video signal V2 has the desired gamma characteristic. In this case, the LUT 212b of the liquid crystal display device 200 stores a result of gamma conversion for converting an input gradation of the video signal V1 into a desired output gradation in place of a result of gamma conversion which is obtained by multiplying brightness corresponding to all input gradations by k (=1). On the other hand, the LUT 212a stores a result of gamma conversion of performing the gamma conversion on the video signal V1 so as to convert the video signal V1 into the video signal having the desired output gradation and then to multiply the brightness corresponding to the low gradation-side input gradations X of the converted video signal by k (=1.5).

The digital gamma conversion part 222 of the liquid crystal display device 200 performs the gamma conversion using the LUT 212a when the temperature of the liquid crystal panel 15 is −10° C. or less, and also performs the gamma conversion using the LUT 212b when the temperature of the liquid crystal panel 15 is higher than −10° C. Then, the digital gamma conversion part 222 outputs the video signal V2, which is subjected to the gamma conversion and has the desired output gradation, to the pseudo multi-gradation processing part 23. According to the liquid crystal display device 200, thus, it is possible to prevent a variation in a gradation having a slow response speed, irrespective of a temperature of the liquid crystal panel 15. Moreover, it is possible to improve a response speed at low cost without performing overshoot drive. Even in the case of changing a gamma value in order to display an image having a desired output gradation, further, according to the liquid crystal display device 200, it is possible to prevent a variation in a gradation having a slow response speed, irrespective of a temperature of the liquid crystal panel 15. Therefore, it is possible to extend a gamma value setting range.

### <1.6 Third Modification Example>

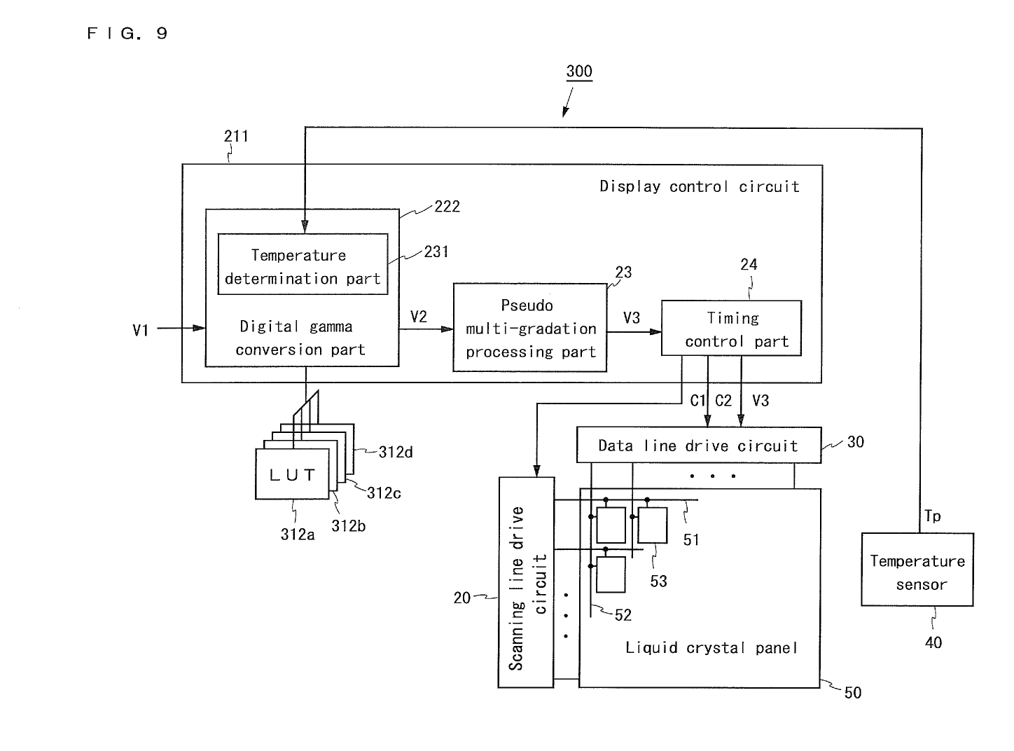

FIG. 9 is a block diagram showing a configuration of a liquid crystal display device 300 according to a third modification example of the first embodiment of the present invention. As shown in FIG. 9, the liquid crystal display device 300 includes a display control circuit 211, a plurality of (four in this modification example) LUTs 312a to 312d, a scanning line drive circuit 13, a data line drive circuit 14, a liquid crystal panel 15 and a temperature sensor 16. The display control circuit 211 includes a digital gamma conversion part 222, a pseudo multi-gradation processing part 23 and a timing control part 24. The digital gamma conversion part 222 includes a temperature determination part 231. In the liquid crystal display device 300 according to this modification example, constituent elements which are identical with those of the liquid crystal display device 200 according to the second modification example are denoted with the same reference symbols in the second modification example, and the description thereof will not be given here.

Among the four LUTs 312a to 312d of the liquid crystal display device 300, the LUT 312d stores a result of gamma conversion identical with the result of gamma conversion which is obtained in the case of k=1.0 and is stored in the LUT 212b shown in FIG. 8. Moreover, the LUT 312a stores the same result of gamma conversion as the result of gamma conversion which is obtained in the case of k=1.2 and is stored in the LUT 112a shown in FIG. 7. The LUT 312b stores the same result of gamma conversion as the result of gamma conversion which is obtained in the case of k=1.5 and is stored in the LUT 112b shown in FIG. 7. The LUT 312c stores the same result of gamma conversion as the result of gamma conversion which is obtained in the case of k=2.0 and is stored in the LUT 112c shown in FIG. 7. For this reason, the description of these results of gamma conversion will not be given here. The table 312a is used when a panel temperature Tp is higher than −20° C., but is −10° C. or less. The table 312b is used when the panel temperature Tp is higher than −30° C., but is −20° C. or less. The table 312c is used when the panel temperature Tp is −30° C. or less. The table 312d is used when the panel temperature Tp is higher than −10° C.

According to the third modification example, the four LUTs 312a to 312d are provided, and the digital gamma conversion part 222 performs gamma conversion using the LUT 312d on a video signal V1 when the panel temperature Tp is higher than −10° C. When the panel temperature Tp is −10° C. or less, the digital gamma conversion part 222 selects one LUT from the LUTs 312a to 312c in accordance with the panel temperature Tp, and performs gamma conversion using the selected LUT on the video signal V1. As described above, in order to perform gamma conversion, the LUT 312d is used when the panel temperature Tp is higher than −10° C., and one of the different LUTs 312a to 312c is used in accordance with the temperature when the panel temperature Tp is −10° C. or less. Thus, it is possible to prevent a variation in a gradation having a slow response speed even when the temperature of the liquid crystal panel 15 is higher than −10° C. According to the liquid crystal display device 300, moreover, when the temperature of the liquid crystal panel 15 is −10° C. or less, the optimal one of the LUTs 312a to 312c is selected in accordance with the temperature, and the gamma conversion can be performed using the selected LUT. Therefore, it is possible to perform more preferable gamma conversion. Therefore, it is possible to further improve a response speed at low cost without performing overshoot drive.

### 2. Second Embodiment

Images are classified into images which are principally still images in a menu screen and the like (hereinafter, referred to as still images) and images which are principally moving images in a TV set, a DVD and the like (hereinafter, referred to as moving images). A moving image is susceptible to an influence of a response speed of a liquid crystal as compared with a still image, and is apt to be deteriorated in display performance. Therefore, it is possible to improve display quality of images as follows. That is, a video signal to be input to a liquid crystal display device is subjected to a determination whether the signal is a moving image or a still image. If it is determined that the video signal is a moving image, a response speed of a liquid crystal is improved.

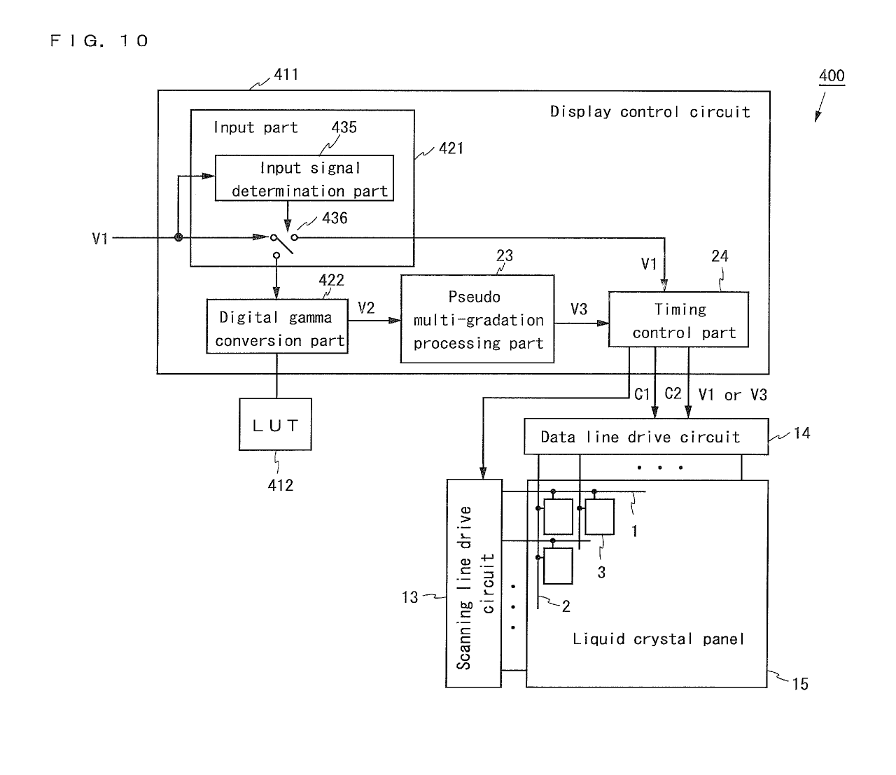

FIG. 10 is a block diagram showing a configuration of a liquid crystal display device 400 according to a second embodiment of the present invention. As shown in FIG. 10, the liquid crystal display device 400 includes a display control circuit 411, one LUT 412, a scanning line drive circuit 13, a data line drive circuit 14 and a liquid crystal panel 15. The display control circuit 411 includes an input part 421, a digital gamma conversion part 422, a pseudo multi-gradation processing part 23 and a timing control part 24. The input part 421 includes an input signal discrimination part 435 and a switch 436. In the liquid crystal display device 400 according to this embodiment, constituent elements which are identical with those of the liquid crystal display device 10 according to the first embodiment are denoted with the same reference symbols in the first embodiment, and the description thereof will not be given here.

A video signal V1 is input to the input part 421 of the liquid crystal display device 400 from the outside. The input video signal V1 is fed to the input signal determination part 435 and switch 436 of the input part 421. The input signal determination part 435 determines whether the video signal V1 is a still image or a moving image. When it is determined that the video signal V1 is a still image, the input signal determination part 435 switches the switch 436 toward the timing control part 24. Thus, the video signal V1 determined as a still image is output to the timing control part 24. On the other hand, when it is determined that the video signal V1 is a moving image, the input signal determination part 435 switches the switch 436 toward the digital gamma conversion part 422. Thus, the video signal V1 determined as a moving image is output to the digital gamma conversion part 422.

When the video signal V1 determined as a moving image is input to the digital gamma conversion part 422, the digital gamma conversion part 422 performs gamma conversion using the LUT 412 on the video signal V1 to output a video signal V2, which is larger in gradations than the video signal V1, to the pseudo multi-gradation processing part 23. The LUT 412 stores a result of gamma conversion which is obtained by multiplying brightness corresponding to low gradation-side input gradations X by k (=1.5) with regard to brightness of an image based on the video signal V1, and a result of gamma conversion on a high gradation side, which is adjusted by an operator. The pseudo multi-gradation processing part 23 performs pseudo multi-gradation processing on the video signal V2 to output a video signal V3, which is equal in gradations to the video signal V1, to the timing control part 24.

The timing control part 24 outputs a control signal C1 to the scanning line drive circuit 13, and also outputs a control signal C2 to the data line drive circuit 14. Further, the timing control part 24 outputs a video signal to the data line drive circuit 14 at an appropriate timing. Specifically, the timing control part 24 outputs the video signal V3 when the video signal V1 input to the liquid crystal display device 400 is a moving image, and outputs the video signal V1 when the video signal V1 is a still image. In the pseudo multi-gradation processing part 23, processing to be performed after the pseudo multi-gradation processing is identical with that in the liquid crystal display device 10 shown in FIG. 1, and therefore the description thereof will not be given here.

According to the second embodiment, the liquid crystal display device 400 according to this embodiment includes: the liquid crystal panel 15; the input part 421 making a determination as to the type of the input video signal V1, and dividing the video signal on the basis of the result of determination; the digital gamma conversion part 422 performing the gamma conversion on the video signal V1 determined as a moving image; the scanning line drive circuit 13 and the data line drive circuit 14 each driving the liquid crystal panel 15 on the basis of the video signal V3 obtained by performing the pseudo multi-gradation processing on the video signal V2 subjected to the gamma conversion; and the LUT 412 storing the result of gamma conversion to be used when the video signal V1 is a moving image. The LUT 412 stores the result of gamma conversion of obtaining the video signal V2 by multiplying the brightness corresponding to the low gradation-side input gradations X by k with regard to the brightness of the image based on the video signal V1. When the video signal V1 is subjected to the gamma conversion using the LUT 412, output gradations corresponding to the low gradation-side input gradations X are enhanced by the multiplication by k. Thus, it is possible to improve a response speed of a liquid crystal upon reception of a video signal V1 determined as a moving image. Therefore, it is possible to display a high-quality moving image on the liquid crystal panel 15. According to the liquid crystal display device 400, thus, it is possible to prevent a variation in a gradation having a slow response speed even when the input video signal V1 is a moving image. Moreover, it is possible to improve a response speed at low cost without performing overshoot drive.

### <2.1 Modification Example>

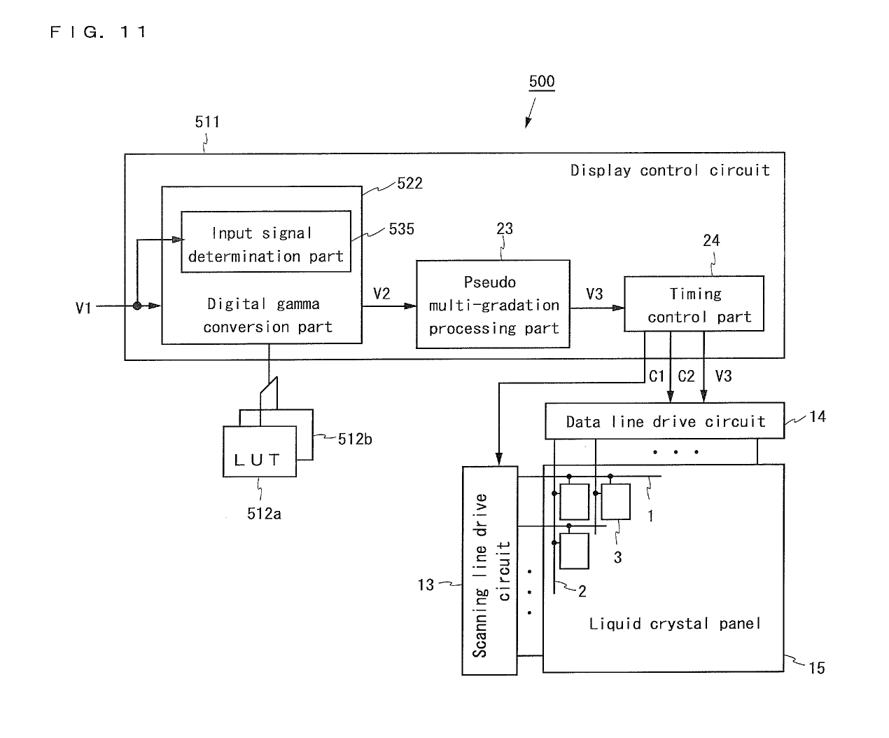

FIG. 11 is a block diagram showing a configuration of a liquid crystal display device 500 according to a modification example of the second embodiment of the present invention. As shown in FIG. 11, the liquid crystal display device 500 includes a display control circuit 511, two LUTs 512a and 512b, a scanning line drive circuit 13, a data line drive circuit 14 and a liquid crystal panel 15. The display control circuit 511 includes a digital gamma conversion part 522, a pseudo multi-gradation processing part 23 and a timing control part 24. The digital gamma conversion part 522 includes an input signal determination part 535. In the liquid crystal display device 500 according to this modification example, constituent elements which are identical with those of the liquid crystal display device 400 according to the second embodiment are denoted with the same reference symbols in the second embodiment, and the description thereof will not be given here.

A video signal V1 is input to the digital gamma conversion part 522 of the liquid crystal display device 500 from the outside. The input signal determination part 535 of the digital gamma conversion part 522 determines whether the input video signal V1 is a moving image or a still image. When the input signal determination part 535 determines that the video signal V1 is a moving image, the digital gamma conversion part 522 performs gamma conversion using the LUT 512a on the video signal V1. On the other hand, when the input signal determination part 535 determines that the video signal V1 is a still image, the digital gamma conversion part 522 performs gamma conversion using the LUT 512b on the video signal V1. The LUT 512a is identical with the LUT 412. The LUT 512b stores a result of gamma conversion which is obtained by multiplying brightness corresponding to all input gradations by k (=1).

The digital gamma conversion part 522 outputs a video signal V2, which is larger in gradations than the video signal V1 determined as a moving image or a still image, to the pseudo multi-gradation processing part 23. In the pseudo multi-gradation processing part 23, processing to be performed after the pseudo multi-gradation processing is identical with that in the liquid crystal display device 400, and therefore the description thereof will not be given here.

According to this modification example, when the input signal determination part 535 determines that the video signal V1 is a moving image, the digital gamma conversion part 522 performs the gamma conversion using the LUT 512a. Moreover, when the input signal determination part 535 determines that the video signal V1 is a still image, the digital gamma conversion part 522 performs the gamma conversion using the LUT 512b. Thus, it is possible to improve the response speed of the liquid crystal when the video signal V1 is a moving image. Therefore, it is possible to display a high-quality moving image on the liquid crystal panel 15. As described above, it is possible to prevent a variation in a gradation having a slow response speed, irrespective of the type of the video signal V1. Moreover, it is possible to improve a response speed at low cost without performing overshoot drive.

As in the first embodiment, with regard to the liquid crystal display device 500, in the case where the gamma characteristic of the video signal V1 displayed on the liquid crystal panel 15 is displaced from a desired gamma characteristic (for example, γ=2.2), there is a necessity to correct the video signal V2 subjected to the gamma conversion by the digital gamma conversion part 522 such that the video signal V2 has the desired gamma characteristic. In this case, the LUT 512b of the liquid crystal display device 500 stores a result of gamma conversion for converting an input gradation of the video signal V1 into a desired output gradation in place of a result of gamma conversion which is obtained by multiplying brightness corresponding to all input gradations by k (=1). On the other hand, the LUT 512a stores a result of gamma conversion of performing the gamma conversion on the video signal V1 so as to convert the video signal V1 into the video signal having the desired output gradation and then to multiply the brightness corresponding to the low gradation-side input gradations X of the converted video signal by k (=1.5).

The digital gamma conversion part 522 of the liquid crystal display device 500 performs the gamma conversion using the LUT 512a when the video signal V1 is a moving image, and also performs the gamma conversion using the LUT 512b when the video signal V1 is a still image. Then, the digital gamma conversion part 522 outputs, to the pseudo multi-gradation processing part 23, the video signal V2 which is subjected to the gamma conversion and has the desired output gradation. According to the liquid crystal display device 500, thus, it is possible to prevent a variation in a gradation having a slow response speed even when the input video signal V1 is a moving image. Moreover, it is possible to improve a response speed at low cost without performing overshoot drive. Even in the case of changing a gamma value in order to display an image having a desired output gradation, further, according to the liquid crystal display device 500, it is possible to prevent a variation in a gradation having a slow response speed, irrespective of the type of the video signal V1. Therefore, it is possible to extend a gamma value setting range.

### 3. Comparative Example

The liquid crystal panel 15 of the liquid crystal display device according to each of the foregoing embodiments and the modification examples thereof is a liquid crystal panel for a normally black mode (a vertical alignment mode). However, examples of a liquid crystal panel also include a liquid crystal panel for a normally white mode in a TN (Twisted Nematic) method, in addition to the liquid crystal panel for the normally black mode. Hence, the inventors of the present invention conducted experiment as to whether or not a response speed of a liquid crystal is improved in the case where a liquid crystal panel for a normally white mode is used for the liquid crystal display device 10 shown in FIG. 1 in place of the liquid crystal panel 15.

The liquid crystal display device used in the experiment includes an LUT a and an LUT b. Herein, the LUT b stores a result of gamma conversion which is obtained by setting at 1 a value of k in Equation (2) to be used when a result of gamma conversion is obtained on the basis of a low gradation-side input gradation X, the LUT a stores a result of gamma conversion which is obtained by setting the value of k at 1.5.

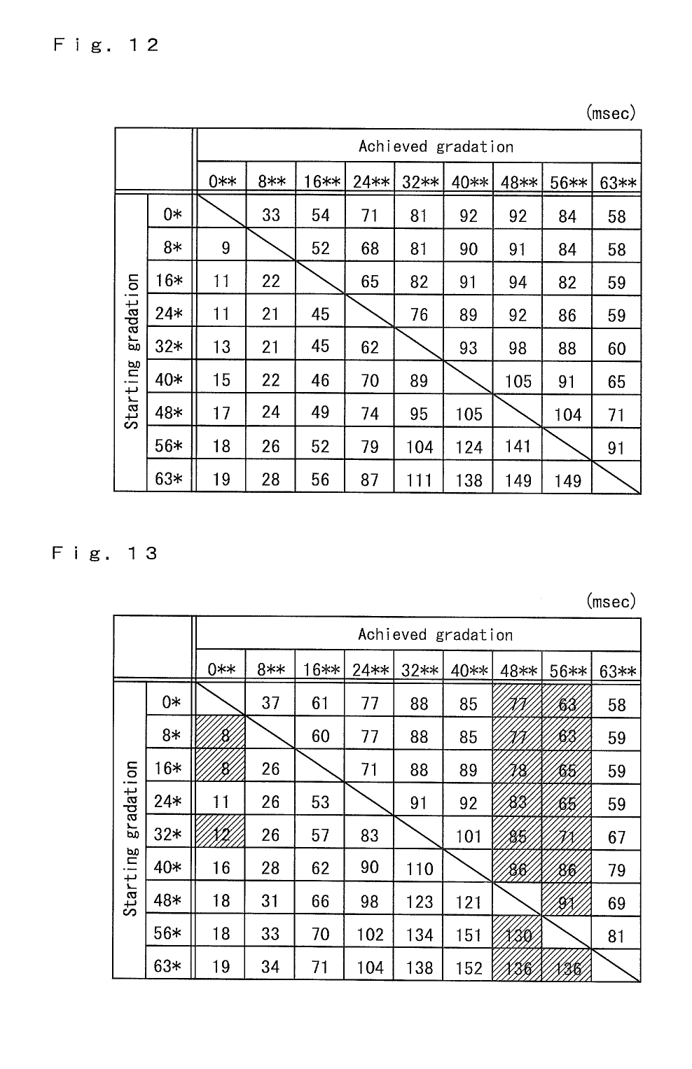

In the experiment, a comparison was made between the response speed of the liquid crystal in the case where the gamma conversion using the LUT a is performed on the video signal V1 and the response speed of the liquid crystal in the case where the gamma conversion using the LUT b is performed on the video signal V1, at a panel temperature Tp of −20° C. in the liquid crystal display device. FIG. 12 is a diagram showing the response speed of the liquid crystal in the case of performing the gamma conversion using the LUT b. FIG. 13 is a diagram showing the response speed of the liquid crystal in the case of performing the gamma conversion using the LUT a. As shown in FIGS. 12 and 13, when the gamma conversion using the LUT a is performed on the video signal V1, the response speed of the liquid crystal is improved slightly in the case where the achieved gradation is high as compared with the gamma conversion using the LUT b. However, with regard to the low gradation-side starting gradation, the response speed is slow. As described above, in the liquid crystal panel for the normally white mode, even in the case of performing the gamma conversion using the LUT a storing the result of gamma conversion which is obtained by multiplying the brightness corresponding the low gradation-side input gradations X by k with regard to the brightness of the image based on the video signal V1, it may be impossible to considerably improve the response speed of the liquid crystal on the low temperature condition, as compared with the liquid crystal panel for the normally black mode. Even in the case of using the liquid crystal panel for the normally white mode, however, it is possible to improve the response speed of the liquid crystal to a certain degree at low cost.

### 4. Others

Various modification examples may be devised for the liquid crystal display device according to each of the foregoing embodiments of the present invention. For example, the temperature sensor may be provided on a place other than the surface of the liquid crystal panel (for example, a surface of a housing of a liquid crystal module including a liquid crystal panel) to sense, as the temperature of the liquid crystal panel, a temperature having a certain bearing on the surface temperature of the liquid crystal panel. In each of the forgoing embodiments and modification examples thereof, moreover, the display control circuit may be integrated with at least one of the scanning line drive circuit and the data line drive circuit. Further, a display device other than the liquid crystal display device may be configured by the respective methods. The liquid crystal display device and display device according to these modification examples also produce similar effects to those of the liquid crystal display devices according to the first and second embodiments.

As described above, the display device according to the present invention is capable of improving a response speed at low cost without performing overshoot drive.

### INDUSTRIAL APPLICABILITY

The present invention is suitable for display devices capable of reducing delay of a variation in a gradation even when a temperature of a liquid crystal panel is low or even when an image to be displayed on the basis of a video signal is a moving image.

### EXPLANATION OF REFERENCE SYMBOLS

10, 100, 200, 300, 400, 500 . . . Liquid crystal display device

11, 211, 411, 511 . . . Display control circuit

12, 112a to 112c, 212a to 212b, 312a to 312d, 412, 512a to 512b . . . LUT

13 . . . Scanning line drive circuit

14 . . . Data line drive circuit

15 . . . Liquid crystal panel

16 . . . Temperature sensor

21, 421 . . . Input part

22, 222, 422, 522 . . . Digital gamma conversion part

23 . . . Pseudo multi-gradation processing part

24 . . . Timing control part

31, 231 . . . Temperature determination part

435, 535 . . . Input signal determination part

32, 436 . . . Switch

1. A display device performing gamma conversion on an input video signal to display an image,
the display device comprising:
a display panel;
a digital gamma conversion part performing the gamma conversion on the input video signal;
a drive part driving the display panel on the basis of the video signal subjected to the gamma conversion;
a timing control part outputting the video signal and a control signal to the drive part at a predetermined timing;
a first table to be used when the digital gamma conversion part performs the gamma conversion; and
a determination part making a determination whether or not a predetermined condition is satisfied, wherein
the first table stores a result of gamma conversion of converting the input video signal so as to obtain brightness by multiplying brightness corresponding to low gradation-side input gradations of the input video signal by a predetermined magnification, and
the digital gamma conversion part performs the gamma conversion using the first table when it is determined that the predetermined condition is satisfied.

2. The display device according to claim 1, further comprising:
a temperature sensing part sensing a temperature of the display panel; and
a switch to be switched so as to output the input video signal to one of the digital gamma conversion part and the timing control part, wherein
the determination part determines whether or not the temperature sensed by the temperature sensing part is higher than a predetermined value,
the switch is switched so as to output the input video signal to the digital gamma conversion part when it is determined that the sensed temperature is the predetermined value or less, and
the switch is switched so as to output the input video signal, which is not subjected to the gamma conversion, to the timing control part when it is determined that the sensed temperature is higher than the predetermined value.

3. The display device according to claim 1, further comprising:
a temperature sensing part sensing a temperature of the display panel; and
a second table storing a result of gamma conversion which is obtained by setting at 1 the magnification for the multiplication of the brightness corresponding to all the input gradations of the input video signal, wherein
the determination part is included in the digital gamma conversion part to determine whether or not the temperature sensed by the temperature sensing part is higher than a predetermined value,
the digital gamma conversion part performs the gamma conversion using the first table when it is determined that the sensed temperature is the predetermined value or less, and
the digital gamma conversion part performs the gamma conversion using the second table when it is determined that the sensed temperature is higher than the predetermined value.

4. The display device according to claim 1, further comprising a temperature sensing part sensing a temperature of the display panel; wherein
the first table includes a plurality of tables storing different results of gamma conversion in accordance with a temperature,
among the plurality of tables, a table to be used at a lower temperature stores a result of gamma conversion which is obtained by setting the predetermined magnification at a larger value, and
the digital gamma conversion part selects one table from the plurality of tables in accordance with the temperature sensed by the temperature sensing part, and performs the gamma conversion using the selected table.

5. The display device according to claim 1, further comprising:
a temperature sensing part sensing a temperature of the display panel; and
a third table storing a result of gamma conversion for converting the input gradation of the input video signal into a desired output gradation, wherein
the first table stores a result of gamma conversion of converting the input video signal so as to convert the input gradation into the desired output gradation and then obtain brightness by multiplying the brightness corresponding to the low gradation-side input gradations by the predetermined magnification,
the determination part is included in the digital gamma conversion part to determine whether or not the temperature sensed by the temperature sensing part is higher than a predetermined value,
the digital gamma conversion part performs the gamma conversion using the first table when it is determined that the sensed temperature is the predetermined value or less, and
the digital gamma conversion part performs the gamma conversion using the third table when it is determined that the sensed temperature is higher than the predetermined value.

6. The display device according to claim 1, further comprising:
a switch to be switched so as to output the input video signal to one of the digital gamma conversion part and the timing control part in accordance with the result of determination by the determination part, wherein
the determination part determines a type of the input video signal,
the switch is switched so as to output the input video signal to the digital gamma conversion part when it is determined that the input video signal is a moving image, and
the switch is switched so as to output the input video signal, which is not subjected to the gamma conversion, to the timing control part when it is determined that the input video signal is a still image.

7. The display device according to claim 1, further comprising:
a second table storing a result of gamma conversion which is obtained by setting at 1 the magnification for the multiplication of the brightness corresponding to all the input gradations of the input video signal, wherein
the determination part is included in the digital gamma conversion part to determine a type of the input video signal,
the digital gamma conversion part performs the gamma conversion using the first table when it is determined that the input video signal is a moving image, and
the digital gamma conversion part performs the gamma conversion using the second table when it is determined that the input video signal is a still image.

8. The display device according to claim 1, further comprising:
a third table storing a result of gamma conversion for converting the input gradation of the input video signal into a desired output gradation, wherein
the first table stores a result of gamma conversion of converting the input video signal so as to convert the input gradation into the desired output gradation and then obtain brightness by multiplying the brightness corresponding to the low gradation-side input gradations by the predetermined magnification,
the determination part is included in the digital gamma conversion part to determine a type of the input video signal,
the digital gamma conversion part performs the gamma conversion using the first table when it is determined that the input video signal is a moving image, and
the digital gamma conversion part performs the gamma conversion using the third table when it is determined that the input video signal is a still image.

9. The display device according to claim 1, wherein
the predetermined magnification is larger than 1, but 2 or less.

10. The display device according to claim 1, wherein
the digital gamma conversion part converts the input video signal into a video signal which is larger in gradations than the input video signal,
the display device further comprising
a pseudo multi-gradation processing part performing pseudo multi-gradation processing on the video signal output from the digital gamma conversion part, and outputting the resultant video signal to the timing control part.

11. The display device according to claim 1, wherein
the display panel is a liquid crystal panel for a normally black mode.
